(19) United States
(12) Patent Application Publication
(10) Pub. No.: US 2021/0339696 A1
(43) Pub. Date: Nov. 4, 2021

(54) Portable, Folding Passenger Vehicle Partition

(71) Applicant: Sergio Ramon Morales, Mount Laurel, NJ (US)

(72) Inventor: Sergio Ramon Morales, Mount Laurel, NJ (US)

(21) Appl. No.: 16/863,762

(22) Filed: Apr. 30, 2020

(51) Int. Cl. B60R 21/02; B60R 21/12

(52) U.S. Cl. CPC B60R 21/026; B60R 2021/0266; B60R 21/12

(57) ABSTRACT

A folding a partition consist of an acrylic partition having folding panels, and a set of hinges to secure and give the capability of folding the panels of the acrylic partition. There are two vertical legs, for elevation, that are removably secured to the folding panels of the acrylic partition. The acrylic partition comes with a set of utility straps, and the utility straps are utilized to secure the acrylic partition inside the vehicle onto the center post of that vehicle, for safe horizontal positioning of the acrylic partition as it stands positioned behind the front seats.

### CROSS-REFERENCE TO RELATED APPLICATIONS

This present specification claims priority to provisional patent application 62/875,572, filed Jul. 18, 2019, and all disclosure of that patent case is incorporated at least by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

### 1. Field of Invention

The present invention is in the field of passenger vehicle partitions. In particular, the invention relates to a portable, folding acrylic passenger vehicle partition made for passenger vehicles.

### 2. Description of Related Art

### Discussion of the State of the Art

In the art of the passenger vehicle partition, limited types of partitions have been developed for passenger vehicle safety for users. Passenger vehicle partitions include the traditional professionally installed acrylic style partitions as seen in many police and taxi vehicles. Limousines are known to have a mechanical style partition for privacy. Also for ride share vehicles you can purchase a polycarbonate made partition that is secured as one piece to the two front seat headrest to create a partial barrier with multiple attachments and variations available; but the key being the headrest and attachments are vital for the use of this style of partition.

One problem with the traditional passenger vehicle partition is the professional installation needed. Due to the changes of the ride share industry this is not practical for every vehicle to have installed. Also, the traditional passenger vehicle partition will alter your vehicles' body and interior causing repairs to be needed post removal. With todays' ride share industry changing with the use of the publics personal vehicles it is not practical for drivers to consider the tradition partition as an option.

Another limitation in passenger vehicle partitions, the partition available that secures on to the car seats with the use of the head rest does not provide full coverage as a traditional partition and lacks the ability to be used in every vehicle. Also, this partition is not portable or allow for simple removal at any time. The installation requirements limit the different assortment of passenger vehicles that may benefit from this system. The success of this system solely relies on being able to attach to the front seats and held on by the head rest also limiting its reliability. Also, not easy to store away in your vehicle due to its size and structure for desired use.

Current partitions need to allow for easy convenient installation, installation for a larger variety of passenger vehicles to accommodate the ride share industry of today, and full coverage between rear passengers and drivers while giving the same sense of security as a traditional partition. An auto partition should be portable, folding for easy storage, and convenient. It should provide substantial coverage in its original form, otherwise it becomes a complex system not practical for the passenger vehicle partition industry that we have become familiar with today.

Therefore, what is clearly need is a passenger vehicle partition that solves the problems mentioned above.

### BRIEF SUMMARY OF THE INVENTION

In one embodiment of the invention a passenger vehicle partition is provided comprising an acrylic partition having panels, and a set of hinges to secure and give the capability of folding to said panels of said passenger vehicle partition, two adjustable leg members removably secured to said panels of said passenger vehicle partition, and a set of utility straps, characterized in that, the said utility straps are detachable to secure said passenger vehicle partition to a passenger vehicles center post for safe horizontal positioning of said passenger vehicle partition.

Also, in one embodiment the said adjustable leg members are adjustable from a threaded style leg to allow manual vertical movement to said passenger vehicle partition for positioning. Also, in one embodiment the set of said hinges and said adjustable leg members are strategically secured to said folding panels of said acrylic partition by a set of joint connector nut and bolts. Also in one embodiment further comprising a set of said utility straps, which is important for installation, the said utility straps secure the said passenger vehicle partition to a passenger vehicle at the center post of a passenger vehicle while the said passenger vehicle partition is positioned behind the front seats of a passenger vehicle. Also, in one embodiment the said passenger vehicle partition is composed of, but not limited to, three Plexiglas panels.

In another aspect of the invention the said adjustable leg members vertically elevate the said passenger vehicle partition to the highest point inside of a passenger vehicle while positioned behind the front seats for best results during use.

In another aspect a set of said hinges comprises the ability to fold horizontally allowing the said panels to fold inward with said hinges making the said passenger vehicle partition foldable. Also in another embodiment a set of said hinges comprises the ability to be open allowing said passenger vehicle partition to expand while said passenger vehicle partition is positioned behind the front seats of a passenger vehicle, in this form the said hinges allow the said passenger vehicle partition to be properly used.

### BRIEF DESCRIPTION OF THE SEVERAL VIEWS OF THE DRAWINGS

FIG. 1 is an elevation view of an automotive partition according to an embodiment of the present invention.

FIG. 2 is an elevation view of the automotive partition of FIG. 1.

FIG. 3 is a top view of the automotive partition of FIG. 1.

FIG. 4 is a side view of the automotive partition of FIG. 1.

FIG. 5 is an angled view of another embodiment of the automotive partition in FIG. 1 depicting installation inside a vehicle.

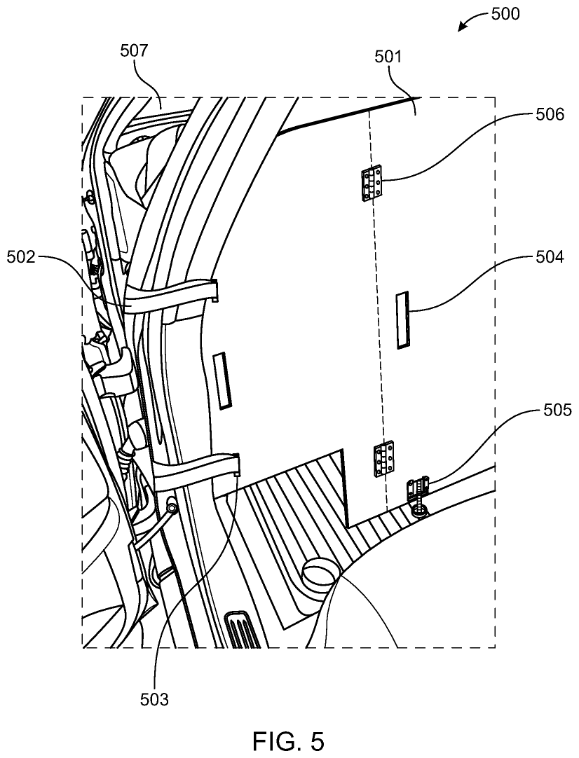

### DETAILED DESCRIPTION OF THE INVENTION

The inventor provides a unique portable, folding vehicle partition enabling users to place in and out of all kinds of vehicles as often as they like. This new passenger vehicle partition incorporates the presence of a barrier between passenger and driver as we are currently accustomed to, but without the need of professional installation or having to attach to the vehicles' seats in any way. The present invention is described in enabling detail in the following examples, which may represent more than one embodiment of the present invention.

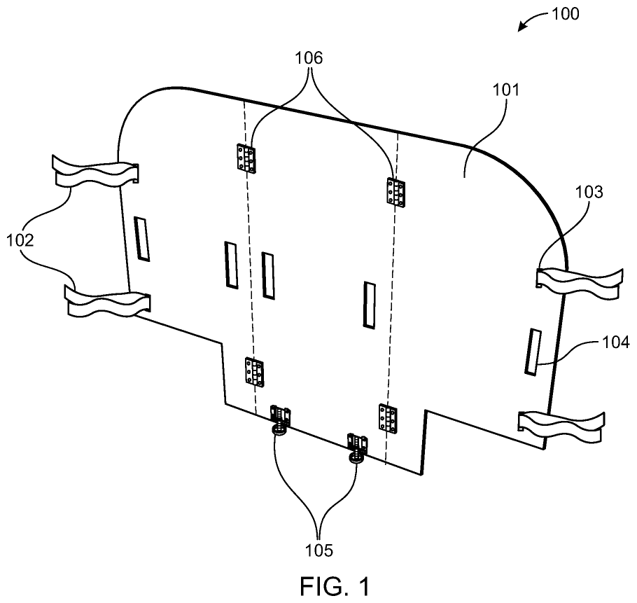

FIG. 1 is an elevation view of a passenger vehicle partition 100 according to an embodiment of the present invention. Passenger vehicle Partition 100 in this example a passenger vehicle partition that produces commercially for the consumer market. Passenger vehicle partition 100 has a plurality of acrylic panels 101 held together by hinges 106 giving the ability to fold when not in use for easy storage. In this view the hinges 106, straps 102, and legs 105 are visible in each of three illustrated panels 101.

Passenger vehicle Partition 100 has panels 101 with slots 103 for utility straps 102 to go through the slots and become secured strap 502 to the post of a vehicle. In this example. the automotive partition 100 is elevated at its highest point in a vehicle by no the expandable legs 105 putting it in its intended position.

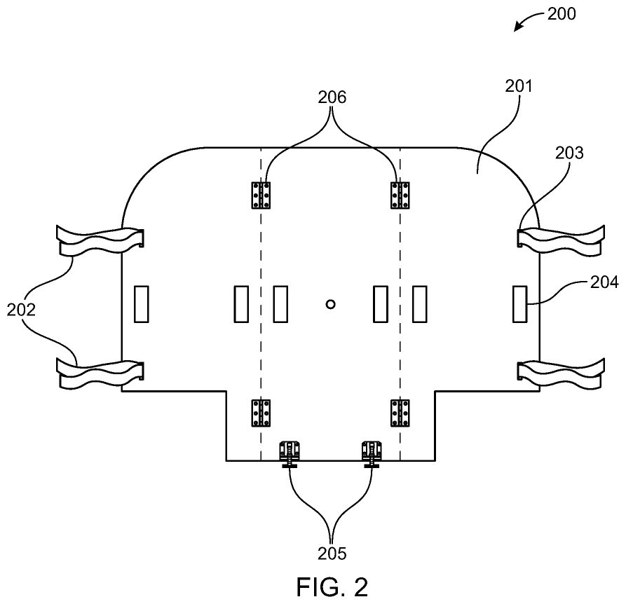

FIG. 2 is a perspective view of a passenger vehicle partition 200 illustrating an escalated view according to an embodiment of the present invention. Those components that are unchanged in this embodiment retain their original element numbers and are not reintroduced.

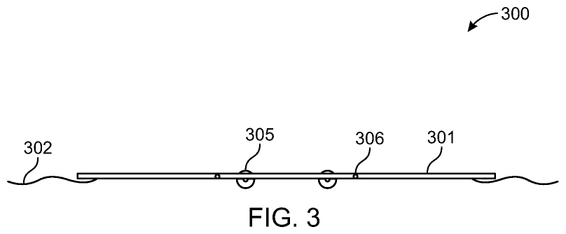

FIG. 3 is a top view of a passenger vehicle partition 300 according to an embodiment of the present invention. Those components that are unchanged in this embodiment retain their original element numbers and are not reintroduced.

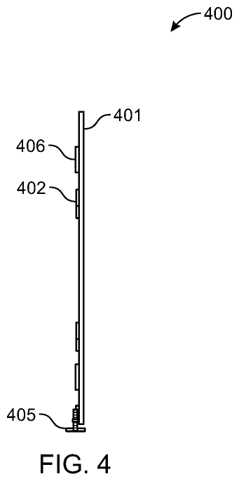

FIG. 4 is a side view of a passenger vehicle partition 400 according to an embodiment of the present invention. Those components that are unchanged in this embodiment retain their original element numbers and are not reintroduced.

Fig, 5 is a perspective view of a passenger vehicle partition 500 illustrating a passenger vehicle partition installed in a vehicle. In this embodiment illustration shows secured utility straps 502 from the slots 503 of the passenger vehicle partition 100 to the center post of a vehicle while placed behind the front seats. Also, in another embodiment the legs 505 are expanded vertically the hinges 506 are in the open position allowing the passenger vehicle partition 100 to be positioned as intended in a vehicle. Placed in this position illustrated in this embodiment it allows for proper use.

It will be apparent to one with skill in the art that the portable, folding passenger vehicle partition of the invention may be provided using some of all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A folding passenger vehicle partition, comprising:
an acrylic partition having folding panels;
a set of hinges to secure and give the ability of folding to said panels of said acrylic partition;
two height adjustable leg members removably secured to said folding panels of said passenger vehicle partition; and
a set of utility straps,
characterized in that, the straps are detachable to secure said passenger vehicle partition to a vehicle for secured horizontal positioning of said passenger vehicle partition.

2. A folding passenger vehicle partition as in claim 1, wherein said height adjustable leg members are adjustable from a threaded style leg to allow manual vertical movement by rotating the said thread style leg accordingly for desired height of said folding passenger vehicle partition.

3. A folding passenger vehicle partition as in claim 1, wherein said set of hinges and said adjustable leg members are removably secured to said folding panels of said folding passenger vehicle partition by a set of joint connector nut and bolts.

4. A folding passenger vehicle partition as in claim 1, further comprising a set of said utility straps, which is important for installation; the said utility straps secure the said folding passenger vehicle partition to a vehicle at the center post of a vehicle while the said folding passenger vehicle partition is positioned behind the front seats of a vehicle.

5. A folding passenger vehicle partition as in claim 1, wherein the said folding passenger vehicle partitions' material is composed of, but not limited to three Plexiglas panels.

6. A folding passenger vehicle partition as in claim 2, wherein comprising said height adjustable leg members vertically elevate the said folding passenger vehicle partition at the highest point inside of a vehicle while positioned behind the front seats of that vehicle.

7. A folding passenger vehicle partition as in claim 3, wherein said set of hinges comprises the ability to fold horizontally allowing the said panels to close together making the said folding passenger vehicle partition foldable.

8. A folding passenger vehicle partition as in claim 3, wherein said set of hinges comprises the ability to open allowing said folding passenger vehicle partition to be expanded horizontally while in a standing upright position while said folding passenger vehicle partition is positioned behind the front seats of a vehicle; in this form the said hinges allow the said folding passenger vehicle partition to be used in its full capacity according to an embodiment of the invention.
